(19) United States
(12) Patent Application Publication
(10) Pub. No.: US 2004/0185224 A1
(43) Pub. Date: Sep. 23, 2004

(54) Foldable cutting pad

(76) Inventor: Chieh-Tang Chen, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 10/809,744

(22) Filed: Mar. 25, 2004

Related U.S. Application Data
(63) Continuation-in-part of application No. 10/163,125, filed on Jun. 6, 2002.

(51) Int. Cl. B32B 3/04

(52) U.S. Cl. 428/121

(57) ABSTRACT

A cutting pad includes at least two main pads with a cut-durable fiber plate sintered on a top surface of the at least two main pads and a plurality of reinforcement cut-durable fiber patches are sintered on the cut-durable fiber plate 3 at the position where the at least two main pads are connected. A cut-durable surface plate is sintered on the cut-durable fiber plate.

### BACKGROUND OF THE INVENTION

### Field of the Invention

The present invention relates to a foldable cutting pad comprising at least two main pads with a cut-durable fiber plate sintered to a top of the main pads and a cut-curable surface plate connected to the top of the cut-durable fiber plate.

2. Description of the Prior Arts

A conventional cutting pad generally includes a single main plate with a cut-durable surface plate sintered on the main plate. An inherent shortcoming is that the cut-durable surface plate has to be long enough so as to meet the needs of the users and the cut-durable plate cannot be folded so that it occupies a lot of space. Once the cutting pad is folded, it is deformed permanently. Some manufacturers compose a large cutting pad by several partitions like puzzles. Although the area of the composed cutting pad is increase, when the knife cuts at the seam positions between the partitions, the knife cannot cut in straight or in curve shape smoothly.

The present invention intends to provide a cutting pad that is foldable.

### SUMMARY OF THE INVENTION

In accordance with one aspect of the present invention, there is provided a cutting pad which comprises at least two main pads with a cut-durable fiber plate sintered on a top surface of the at least two main pads. A plurality of reinforcement cut-durable fiber patches are sintered on the cut-durable fiber plate at the position where the at least two main pads are connected. A cut-durable surface plate is sintered on the cut-durable fiber plate.

The primary object of the present invention is to provide a cutting pad that is composed of at least two main pads and a cut-durable fiber plate sintered to the at least two main pads and a cut-durable surface plate is connected to the cut-durable fiber plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cutting pad of the present invention;

FIG. 2 is a cross sectional view to show the structure of the cutting pad of the present invention;

FIG. 3 is a top view to show the position of the reinforcement cut-durable fiber patches of the cutting pad of the present invention;

FIG. 4 shows that the cutting pad of the present invention can be folded along the seam portion between the main pads;

FIG. 5 shows a knife is used on the cutting pad of the present invention, and

FIG. 6 shows the cutting pad of the present invention includes three main pads and can be folded at two positions.

### DETAILED DESCRIPTION OF THE PREFERRED EMBODIMENT

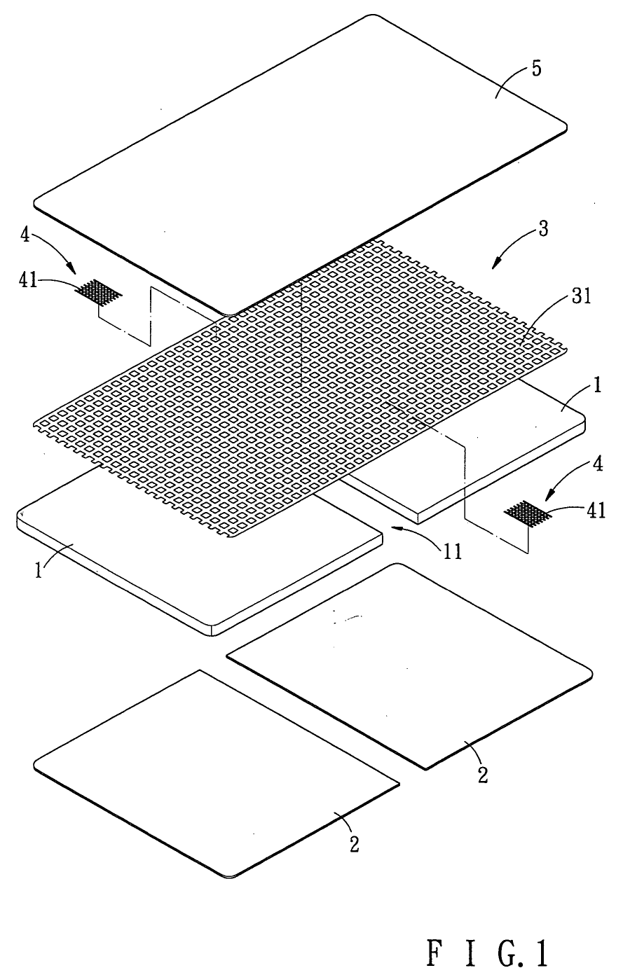

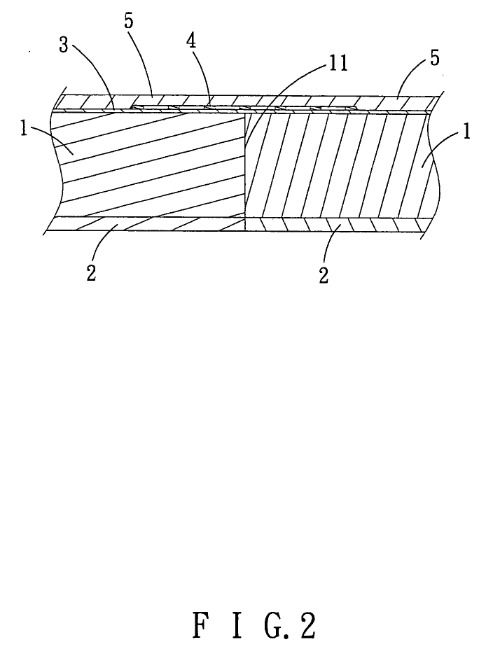

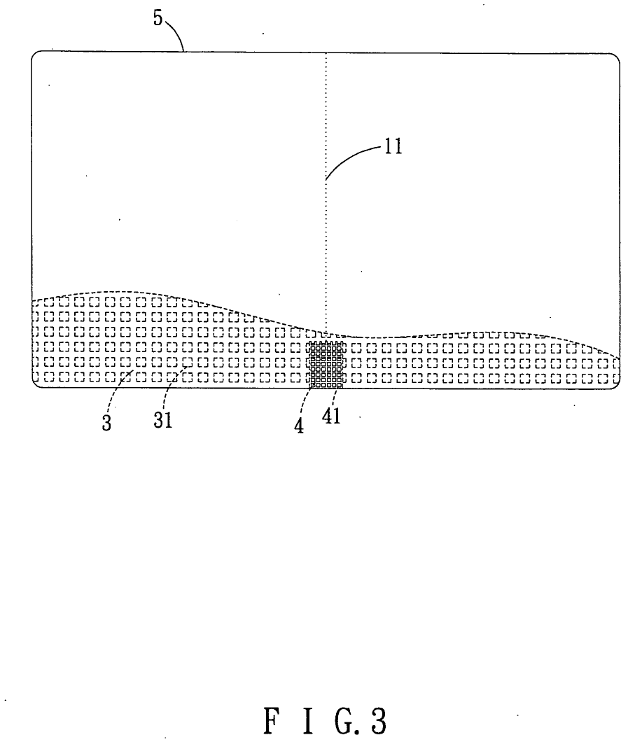

Referring to FIGS. 1 to 3, the cutting pad of the present invention comprises at least two main pads 1 made from PVC and a cut-durable fiber plate 3 made from high-strength nylon fiber is sintered on a top surface of the at least two main pads 1. The cut-durable fiber plate 3 is composed of cut-durable fiber strings woven in a known method. A plurality of reinforcement cut-durable fiber patches 4 made from high-strength nylon fiber are sintered on the cut-durable fiber plate 3 at the seam position 11 where the at least two main pads 1 are connected and each reinforcement cut-durable fiber patch 4 is composed by cut-durable fiber strings woven in a known method. A cut-durable surface plate 5 made from PVC is sintered on the cut-durable fiber plate 3. By such arrangements, the main pads can be folded up along the seam 11.

Two anti-slide plates 2 are connected to a bottom of the at least two main pads 1 so as to prevent the cutting pad from sliding when being used.

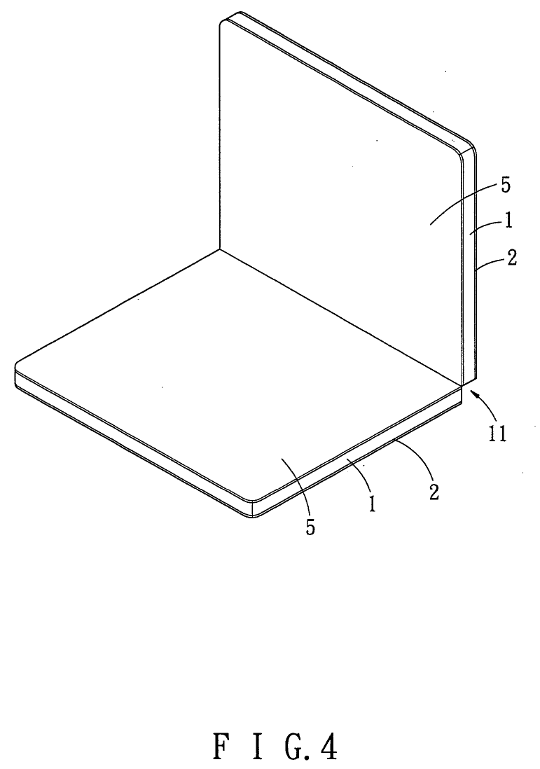

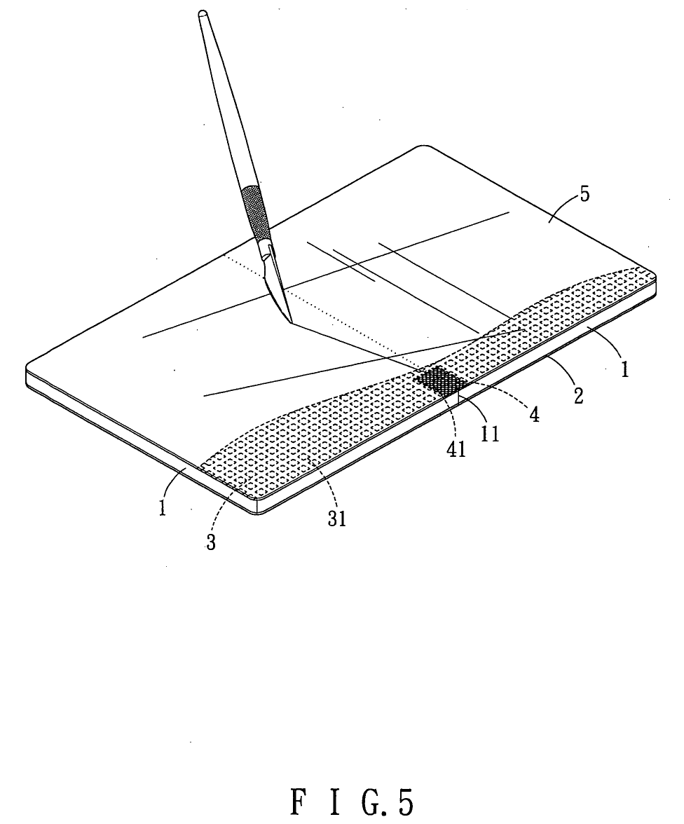

As shown in FIG. 5, although the positions where the reinforcement cut-durable fiber patches 4 are located are slightly convex, the thickness of the reinforcement cut-durable fiber patches 4 are so thin that the users will not feel inconvenience when cutting on the cutting pad of the present invention. As shown in FIG. 4, the cutting pad can be folded at the position 11 where the two main pads 1 are connected.

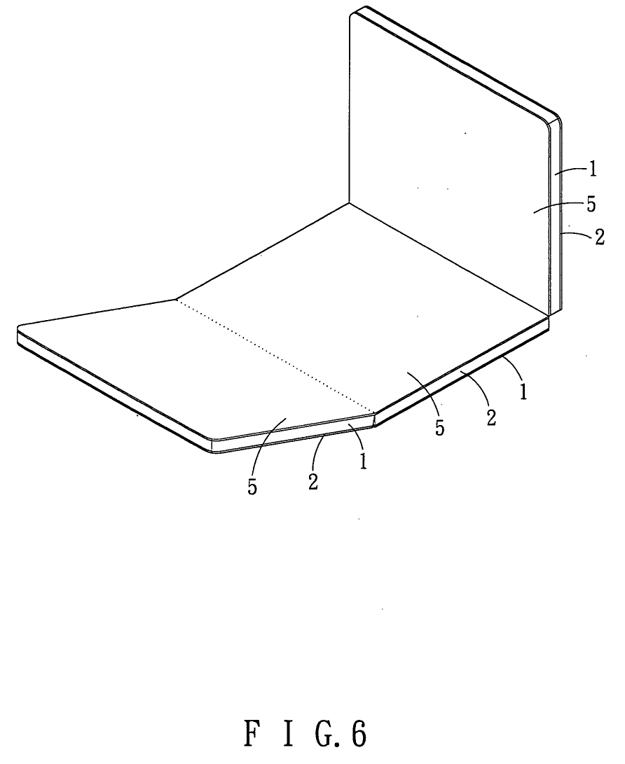

The number of the main pads 1 can be increased such as three as shown in FIG. 6 so that the cutting pad can be folded twice to be a compact size.

While we have shown and described the embodiment in accordance with the present invention, it should be clear to those skilled in the art that further embodiments may be made without departing from the scope of the present invention.

What is claimed is:

1. A foldable cutting pad comprising:
at least two main pads made from PVC, which being arranged in a chain-like manner with a seam left between each of the main pads;
a cut-durable fiber plate made from high-strength nylon fiber being sintered on a top surface of the main pads and also cover the seam between each of the main pads, such that the main pads are connected in succession, a plurality of reinforcement cut-durable fiber patches made from high-strength nylon fiber being sintered on the cut-durable fiber plate at the position where the main pads are connected, and
a cut-durable surface plate made from PVC sintered on the cut-durable fiber plate;
wherein the main pads can be folded up along the seam.

2. The foldable cutting pad as claimed in claim 1 further comprising at least one anti-slide plate connected to a bottom of the at least two main pads.
